(19) United States
(12) Patent Application Publication
(10) Pub. No.: US 2003/0084748 A1
(43) Pub. Date: May 8, 2003

(54) Steering wheel

(76) Inventors: Yasumasa Shimizu, Hamamatsu-shi (JP); Toshiharu Fukushima, Hamamatsu-shi (JP); Toru Makino, Inasa-gun (JP)

Correspondence Address: DICKSTEIN SHAPIRO MORIN & OSHINSKY LLP, 41st Floor, 1177 Avenue of the Americas, New York, NY, 10036-2714, US

(21) Appl. No.: 10/277,054

(22) Filed: Oct. 22, 2002

(30) Foreign Application Priority Data
Oct. 23, 2001 (JP) 2001-325422
Oct. 18, 2002 (JP) 2002-304158

(51) Int. Cl. B62D 1/04

(52) U.S. Cl. 74/552

(57) ABSTRACT

A steering wheel for an automobile is provided. The steering wheel comprises: two surface elements, each formed by stacking a decorative layer and a reinforce layer, joined together at seams; a core material layer disposed to the inside of the surface elements; a metal core disposed to the inside of the core material layer, the surface elements, the core material layer, and the metal core being integrated to form the steering wheel; and fiber reinforcing layers which are provided between the reinforce layer and the core material layer, and which bridge one surface element and the other surface element across the seams of the surface elements. The fiber reinforcing layers are made of material selected from glass fibers, carbon fibers, aramide fibers, and metal fibers. Fibers having lengths of at least 25 mm are scattered in the core material layer. Accordingly, the stress concentration at the seams due to thermal expansion of the core material layer can be prevented, and, cracking, along the seams, in the coating film formed on the surface of the decorative layers can be prevented.

### BACKGROUND OF THE INVENTION

1. Field of the Invention

This invention relates to a steering wheel for an automobile, and specifically relates to a steering wheel comprising a surface layer made of a woody material, and a core element made of resin and disposed to the inside of the surface layer.

2. Background Art

In general, a steering wheel for an automobile comprises a metal core, a core element wrapping around the metal core, and a surface element, and these three elements are integrated together.

As an example of such a steering wheel, a steering wheel, which will be explained below, has been proposed.

FIG. 3 is a cross-sectional view showing a conventional steering wheel.

In general, a steering wheel 1 comprises a metal core 2 consisting of a solid or tubular metal element, a core material layer 3 wrapping around the metal core 2, and a surface element 4. Furthermore, the surface element 4 is formed by stacking a decorative layer 5 as a surface layer, and a reinforce layer 6, so that the reinforce layer 6 is disposed to the inside of the decorative layer 5 (see, for example, Japanese Unexamined Patent Application, First Publication No. 2000-38139).

In the steering wheel 1, the surface elements 4 and 4, which are separately molded, are joined together, and the seams 8 and 8 formed therebetween are located in a plane crossing the metal core 2.

A manufacturing method for a steering wheel such as the steering wheel 1 is outlined below.

As a first step, the decorative layer 5 is preliminarily shaped by a curved-surface shaping process. Then, the decorative layer 5 is disposed in molds, resin is filled in the molds to form the reinforce layer 6, and the surface element 4 is obtained. After the surface elements 4 and 4 are set in the molds, the metal core 2 is disposed to the inside of the surface elements 4 and 4, and resin is filled in the space between the surface elements 4 and 4 and the metal core 2 to form the core material layer 3; thus, a formed body in which the surface elements 4 and 4, the metal core 2, and the core material layer 3 are integrated is obtained. Then, the seams on the formed body are finished with sandpaper or the like, and if necessary, a coloring process, a painting process, a grinding process, or the like is applied to obtain the steering wheel 1.

In the steering wheel 1, because the surface element 4 is formed of two layers, i.e., is formed of the decorative layer 5 and the reinforce layer 6, the surface element 4 is precisely shaped and has high mechanical strength. Therefore, when the surface element 4 having such properties is used, it is easy to set the preliminarily shaped surface element 4 in the molds in the process in which the core part layer 3 is formed; consequently, the formability of the steering wheel 1 is improved.

When the steering wheel 1 is subjected to high temperatures during use, the core material layer 3 made of resin undergoes thermal expansion. When the core material layer 3 expands, stress concentration occurs at the seams 8 and 8 of the surface elements 4 and 4, which may lead to cracking along the seams 8 and 8 in a coating film formed on the surface of the decorative layer 5.

### SUMMARY OF THE INVENTION

In view of the above circumstances, an object of the present invention is to provide a steering wheel in which stress concentration caused by thermal expansion of the core material layer made of resin is mitigated, and consequently, cracking along the seams in the coating film formed on the surface of the decorative layer, are prevented.

The above object is achieved by providing a steering wheel, comprising: two surface elements, each formed by stacking a decorative layer and a reinforce layer, joined together at seams; a core material layer disposed to the inside of the surface elements; a metal core disposed to the inside of the core material layer, the surface elements, the core material layer, and the metal core being integrated to form the steering wheel; and fiber reinforcing layers which are provided between the reinforce layer and the core material layer, and which bridge one surface element and the other surface element across the seams of the surface elements.

The fiber reinforcing layers are preferably of glass fibers, carbon fibers, aramide fibers, or metal fibers.

Preferably, fibers having lengths of at least 25 mm are scattered in the core material layer.

### BRIEF DESCRIPTION OF THE DRAWINGS

FIG. 1 is a cross-sectional view showing an example of the steering wheel according to the present invention.

FIG. 2 is a schematic cross-sectional view showing a manufacturing method for the steering wheel according to the present invention.

FIG. 3 is a cross-sectional view showing a conventional steering wheel.

### DETAILED DESCRIPTION OF THE PREFERRED EMBODIMENTS

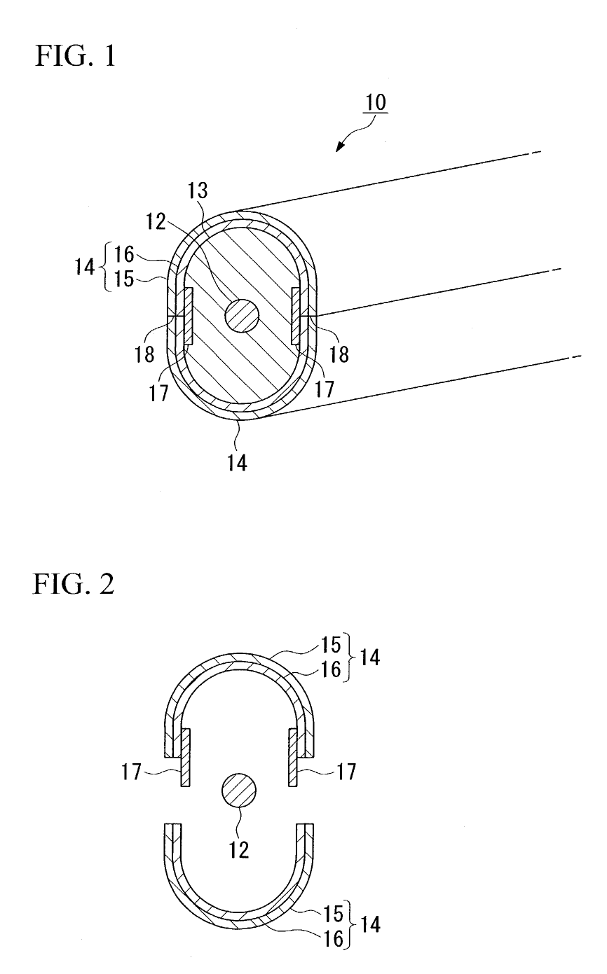

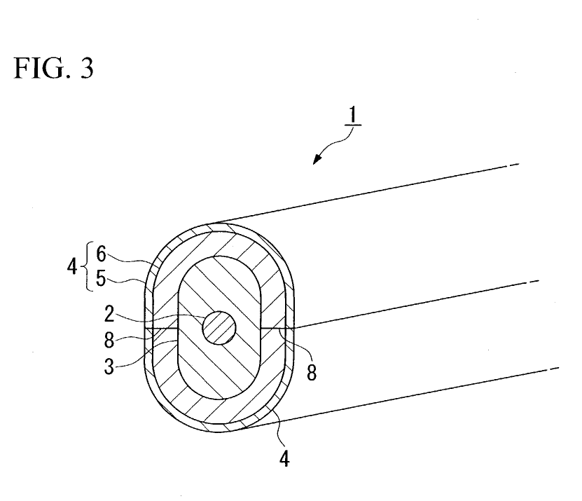

A preferred embodiment of the steering wheel according to the present invention will be explained with reference to FIGS. 1 and 2.

FIG. 1 is a cross-sectional view showing an example of the steering wheel according to the present invention.

The steering wheel 10 primarily comprises a metal core 12, a core material layer 13 wrapping around the metal core 12, surface elements 14, and fiber reinforcing layers 17 provided between the core material layer 13 and the surface elements 14. Each of the surface elements 14 is formed by stacking a decorative layer 15 as a surface layer, and a reinforce layer 16 disposed to the inside of the decorative layer 15.

In the steering wheel 10, the surface elements 14 and 14 which were independently molded are joined together at seams 18 and 18. The seams 18 and 18 are located in a plane crossing the metal core 12. Furthermore, the fiber reinforcing layers 17 bridge one surface element 14 and the other surface element 14 across the seams 18 and 18 of the surface elements 14 and 14.

A coloring process, a painting process, a grinding process, or the like may be applied to the surface of the steering wheel 10, if necessary.

The metal core 12 consists of a solid or tubular metal element made of, for example, iron or the like. The shape of the cross section of the metal core 12 is not limited to a circular shape, but may be, for example, a V-shape, a U-shape, or the like. The metal core 12 may be formed by die-casting a light metal such as aluminum or magnesium.

The core material layer 13 is made of synthetic resin. Examples of synthetic resin to form the core material layer 13 are as follows: foamed resin such as urethane foam, or epoxy foam; thermosetting resin such as urethane resin, phenol resin, or thermosetting polyester; and thermoplastic resin such as polyphenylene sulfide, polycarbonate, acrylonitrile-butadiene-styrene copolymer resin (hereinafter abbreviated as “ABS resin”), polyether imide, polypropylene, polyethylene, acrylic resin, Poly(ether-ether-ketone), polyvinyl chloride, or nylon. Among these materials, a foamed resin such as urethane foam or epoxy foam is preferably used.

The core material layer 13 preferably contains 5 to 60 wt. % of fibers as filler scattered therein. Preferably the fibers are made of fibrous material having high elastic modulus and high strength, such as glass fibers, carbon fibers, aramide fibers, or metal fibers made of, for example, aluminum, steel, or stainless steel, and each of the fibers has a length of at least 25 mm. More preferably, fibers each having a length from 25 to 75 mm may be provided and scattered, as filler, in the core material layer 13.

By scattering fibers having lengths of at least 25 mm in the core material layer 13, the elastic modulus and the heat distortion temperature of the core material layer 13 are increased; consequently, the thermal expansion of the core material layer 13 at high temperatures can be restrained. If the length of each fiber is less than 25 mm, the elastic modulus and the heat distortion temperature of the core material layer 13 are not sufficiently increased; consequently, the thermal expansion of the core material layer 13 at high temperatures cannot be restrained. If the length of each fiber is more than 75 mm, the fibers may not be properly scattered in the synthetic resin even if the contained amount of the fibers relative to the synthetic resin forming the core material layer 13 is small.

If fibers having lengths of 25 mm or more are contained in the core material layer 13 in an amount less than 5 wt. %, the thermal expansion of the core material layer 13 easily occurs. On the other hand, if fibers having lengths of 25 mm or more are contained in the core material layer 13 in an amount greater than 60 wt. %, the formability of the core material layer 13 is degraded.

The density of the core material layer 13 is preferably from 0.1 to 0.5 g/cm³, and more preferably from 0.1 to 0.3 g/cm³. If the density of the core material layer 13 is less than 0.1 g/cm³, the strength of the core material layer 13 is insufficient. On the other hand, if the density of the core material layer 13 is greater than 0.5 g/cm³, the formability of the core material layer 13 is degraded.

The bending strength of the core material layer 13 is preferably from 0.5 to 1.5 MPa, and more preferably from 0.7 to 1.2 MPa. If the bending strength of the core material layer 13 is less than 0.5 MPa, the core material layer 13 cannot hold the metal core 12. If the bending strength of the core material layer 13 is greater than 1.5 MPa, stress caused by the thermal expansion of the core material layer 13 is increased; consequently, the coating film on the decorative layer 15 may have cracking along the seams 18 and 18.

The coefficient of linear expansion of the core material layer 13 is preferably from 0 to 6×10⁻⁵/° C., and more preferably from 0 to 4×10⁻⁵/° C. If the coefficient of linear expansion of the core material layer 13 is greater than 6×10⁻⁵/° C., the reinforce layer 16 wrapping around the core material layer 13 may be deformed, and the coating film formed on the outer surface of the reinforce layer 16 may have cracking, due to the thermal expansion of the core material layer 13.

The surface element 14 is formed by stacking the decorative layer 15 and the reinforce layer 16 so as to be integrated together, and by processing to be curved-surface. The thickness of the surface element 14 is preferably from 0.5 to 3.0 mm, and more preferably from 0.5 to 1.0 mm near the seam 18, and is preferably from 0.5 to 7.0 mm, and more preferably from 0.5 to 3.0 mm at the top thereof.

The material to form the decorative layer 15 may be selected from: (1) a 3-ply decorative sheet in which woody plies are stacked on both surfaces of a thin metal plate; (2) a backed decorative sheet in which a backing material is applied onto a woody ply; (3) a plywood in which a woody ply is stacked, or woody plies are stacked onto the back surface of a woody ply; (4) a ply and resin composite material in which a woody ply and a thin resin plate are stacked; or (5) a film material in which a pattern such as a wood grain pattern is printed on a non-woody material.

The above materials (1) to (5) will be more specifically explained below.

(1) 3-Ply Decorative Sheet

A 3-ply decorative sheet to be used is formed by stacking woody plies as surface layers on both surfaces of a thin metal plate using adhesive or the like so as to be integrated together. The adhesive used to adhere the thin metal plate and the woody plies is not specifically limited, but thermosetting adhesive having heat resistance is preferred.

As the thin metal plate, a metal plate which has flexibility and which has a sufficient strength to reinforce the woody plies stacked on both surfaces thereof. Although the thickness of the thin metal plate should be selected depending on the metal material used, thickness from 0.01 to 0.50 mm is generally preferred. The material for the thin metal plate may be selected from aluminum, aluminum alloy, magnesium, magnesium alloy, titanium, titanium alloy, copper, copper alloy, iron, iron alloy, brass, stainless steel, etc.

One woody ply to be a surface layer and the other woody ply to be an inner layer may be the same as each other; however, specifically, one woody ply to be a surface layer preferably has a beautiful wood grain pattern. The thickness of the woody ply forming the surface layer or inner layer is preferably from 0.15 to 1.00 mm.

(2) Backed Decorative Sheet

A preferable backed decorative sheet to be used is formed by applying a backing material such as non-woven fabric made of, for example, Japanese paper having an area density of approximately 25 to 100 g/m², chemical fibers, or the like as a backing onto a woody ply whose thickness is from 0.15 to 1.00 mm. When such a backed decorative material is used, primer is preferably applied to the back surface thereof so as to increase the adhesion between the decorative layer 15 and the reinforce layer 0.16 attached to the back surface of the decorative layer 15. As the primer, acrylic resin, epoxy resin, urethane resin, or the like may be used. The thickness of the primer is preferably from 20 to 100 μm.

(3) Plywood

A plywood to be preferably used is formed by stacking a woody ply or woody plies onto the back surface of a woody ply, more preferably, a plywood in which one to seven woody plies are stacked onto the back surface of a woody ply is used. The thickness of the woody ply forming the surface layer of the plywood is preferably from 0.15 to 3.00 mm. The thickness of the plywood is preferably from 0.15 to 3.00 mm. If the thickness of the plywood is less than 0.15 mm, the shape retentivity of the plywood is degraded. On the other hand, if the thickness of the plywood is greater than 3.0 mm, the formability of the plywood is degraded.

(4) Ply and Resin Composite Material

A ply and resin composite material to be preferably used is formed by adhering by, for example, a thermosetting adhesive having thermal resistance a thin resin plate whose thickness is from 0.10 to 3.00 mm onto the back surface of a woody ply whose thickness is from 0.15 to 1.00 mm. The thin resin plate is preferably made of polyphenylene sulfide, polycarbonate, ABS resin, or the like.

(5) Film Material

A film material to be preferably used is a film having a designed pattern such as a plastic film printed a pattern thereon, or a film of woven carbon fiber.

The thickness of the reinforce layer 16 is preferably from 0.5 to 7 mm, and more preferably from 0.5 to 3 mm.

The reinforce layer 16 is preferably made of thermoplastic resin such as polyphenylene sulfide, polycarbonate, or ABS resin, or thermosetting resin such as epoxy resin, urethane resin, phenol resin, or polyester resin, or the like. The reinforce layer 16 may contain approximately 0 to 70 wt. % of filler such as glass fibers, carbon fibers, aramide fibers, or wiskers.

The bending strength of the reinforce layer 16 is preferably from 100 to 300 MPa, and more preferably from 150 to 250 MPa. If the bending strength of the reinforce layer 16 is less than 100 MPa, the rigidity of the entire steering wheel 10 is insufficient. If the bending strength of the reinforce layer 16 is greater than 300 MPa, the formability of the surface element 14 formed by stacking the decorative layer 15 and the reinforce layer 16 is degraded.

The Young's modulus of the reinforce layer 16 is preferably from 10 to 25 GPa, and more preferably from 15 to 20 GPa. If the Young's modulus of the reinforce layer 16 is less than 10 GPa, the rigidity of the entire steering wheel 10 is insufficient. If the Young's modulus of the reinforce layer 16 is greater than 25 GPa, the formability of the surface element 14 is degraded.

The coefficient of linear expansion of the reinforce layer 16 is preferably from 0 to 8×10⁻⁵/° C., and more preferably from 0 to 5×10⁻⁵/° C. If the coefficient of linear expansion of the reinforce layer 16 is greater than 8×10⁻⁵/° C., the reinforce layer 16 may be deformed, and the coating film formed on the outer surface of the reinforce layer 16 may have cracking, due to thermal expansion at high temperature.

The reinforce layer 16 may be formed by injecting appropriate material into the inside of the decorative layer 15 which is preliminarily shaped (i.e., injection molding). The reinforce layer 16 may be formed by shaping molding compound in a predetermined shape, and then by stacking the shaped molding compound onto the decorative layer 15 so as to be integrated therewith. The molding compound is such as sheet molding compound (hereinafter abbreviated as SMC), or bulk molding compound (hereinafter abbreviated as BMC) made of the above-mentioned thermoplastic resin or thermosetting resin, and then

In a case in which the reinforce layer 16 is formed of polyphenylene sulfide, the reinforce layer 16 may be formed by injecting polyphenylene sulfide into the inside of the decorative layer 15 which is preliminarily shaped and is set in forming molds. In this case, the temperature of the cylinder of an injection molding machine used for injecting polyphenylene sulfide into the inside of the decorative layer 15 is preferably set in a range from 280 to 320° C., the injection pressure is preferably set in a range from 300 to 1000 kg/cm², and the temperature of the forming molds is preferably set in a range from 80 to 160° C. Alternatively, in a case in which the reinforce layer 16 is formed of polycarbonate in a similar way, the temperature of the cylinder of the injection molding machine is preferably set in a range from 270 to 330° C., the injection pressure is preferably set in a range from 700 to 1500 kg/cm², and the temperature of the forming molds is preferably set in a range from 80 to 130° C. Furthermore, in a case in which the reinforce layer 16 is formed of ABS resin, the temperature of the cylinder of the injection molding machine is preferably set in a range from 150 to 250° C., the injection pressure is preferably set in a range from 700 to 1500 kg/cm², and the temperature of the forming molds is preferably set in a range from 50 to 100° C.

In a case in which the reinforce layer 16 is formed of SMC or BMC, the preliminarily shaped decorative layer 15 is put in forming molds, SMC or BMC having been cut into strips is applied to the decorative layer 15 along the inner surface thereof, and then a heating and pressurizing forming step is performed. In this case, the preferred conditions are as follows: the temperature of the molds is 100 to 150° C.; the mold retaining pressure is 2 to 8 MPa; and the holding period in the mold is 3 to 5 minutes.

The fiber reinforcing layer 17 is preferably formed from a woven fabric or non-woven fabric made of fiber having high elastic modulus and high strength, such as glass fibers, carbon fibers, aramide fibers, or metal fibers made of, for example, aluminum, steel, or stainless steel. The fiber reinforcing layer 17 may be formed by merely bundling fibers such as glass fibers, carbon fibers, aramide fibers, or metal fibers. When such bundled fibers are used, the fibers are preferably disposed along the inner surfaces of the surface elements 14 so that longitudinal directions of the fibers are perpendicular to the seam 18. Furthermore, the material for forming the fiber reinforcing layer 17 may be a prepreg in which thermosetting resin such as polyester resin, epoxy resin, or phenol resin is impregnated into fibers such as glass fibers, carbon fibers, aramide fibers, or metal fibers.

The area density of the woven fabric, non-woven fabric, or fibers forming the fiber reinforcing layer 17 is preferably in a range from 50 to 500 g/m².

The diameter of each of the glass fibers is preferably in an approximate range from 8 to 15 μm, the diameter of each of the carbon fibers is preferably in an approximate range from 5 to 10 μm, the diameter of each of the aramide fibers is preferably in an approximate range from 10 to 15 μm, and the diameter of each of the metal fibers is preferably in an approximate range from 100 to 500 μm.

The fiber reinforcing layer 17 is made of a layer or layers of the above-mentioned woven fabric or non-woven fabric, and the thickness of the fiber reinforcing layer 17 is preferably from 100 to 500 μm, and more preferably from 100 to 300 μm. If the thickness of the fiber reinforcing layer 17 is less than 100 μm, the thermal expansion of the core material layer 13 is not sufficiently suppressed. If the thickness of the fiber reinforcing layer 17 is greater than 300 μm, the formability of the steering wheel 10 is degraded.

The width of the fiber reinforcing layer 17 is preferably from 10 mm to the length of the inner perimeter of the surface elements 14 and 14 in cross section, and more preferably from 10 to 15 mm. If the width of the fiber reinforcing layer 17 is less than 10 mm, the thermal expansion of the core material layer 13 is not sufficiently suppressed.

In FIG. 1, each of the fiber reinforcing layers 17 and 17 is disposed so as to bridge one surface element 14 and the other surface element 14 across the seams 18 of the surface elements 14 and 14; however, the fiber reinforcing layers 17 and 17 may be provided along the entire inner surface of the surface elements 14 and 14.

If the fiber reinforcing layer 17 has substantially same shape as the entire inner surface of the surface elements 14 and 14, the assembly operation can be easily performed because the fiber reinforcing layer 17 can be fit to the inside of the surface elements 14 and 14.

In the steering wheel of this embodiment, because the above-mentioned fiber reinforcing layers 17 and 17 made of material having high elastic modulus and high strength are provided, the thermal expansion of the core material layer 13 at high temperature is restrained, and the elastic modulus and the heat distortion temperature of the core material layer 13 near the seams 18 and 18 are increased; therefore, the stress concentration at the seams 18 and 18 due to thermal expansion of the core material layer 13 can be prevented. Accordingly, cracking, along the seams 18 and 18, in the coating film formed on the surface of the decorative layers 15 and 15 due to thermal expansion of the core material layer 13 can be prevented.

A manufacturing method for the steering wheel according to the present invention will be explained below.

As a first step, one decorative layer 15 for the front side of the steering wheel 10 and the other decorative layer 15 for the back side of the steering wheel 10 are preliminarily shaped by a curved-surface shaping process, respectively. By these preliminary shaping processes, each of the decorative layers 15 are shaped in substantially the final surface shape of the steering wheel 10; however, it is not necessary to make each of the decorative layers 15 to be the final shape at this stage. Only one mold may be used for shaping both of the front side and the back side decorative layers 15; alternatively, the preliminary shaping process for the back side decorative layer 15 may be performed using another mold having irregularities for better grip during use.

The preliminary shaping process for the decorative layer 15 may be performed using a hot press process, a vacuum press process, a vacuum forming, a pressurized air forming, or the like, among which a hot press process and a vacuum press process are preferably used. The operating conditions for the hot press process are preferably set to 1 to 5 minutes at 80 to 140° C., and the operating conditions for vacuum press process are preferably set to 1 to 10 minutes at 80 to 140° C. The decorative layer 15 may be subjected to a known moistening process or a known alkaline treatment using ammonia so as to be softened. By applying such a pretreatment, to the decorative layer 15, cracking in the decorative layer 15 during the curved-surface shaping process can be prevented; thus, the formability thereof is improved.

Next, the reinforce layer 16 is formed, and the reinforce layer 16 is stacked onto the decorative layer 15 so as to obtain the integrated surface element 14.

The integrated surface element 14 may be formed by injecting appropriate material to be the reinforce layer 16 (i.e., injection molding) into the inside of the decorative layer 15 which is preliminarily shaped. The integrated surface element 14 may be formed by forming the reinforce layer 16 in a predetermined shape with a molding compound, and then by stacking the shaped reinforce layer 16 onto the decorative layer 15 so as to be integrated. The molding compound is such as SMC or BMC made of thermoplastic resin or thermosetting resin.

When the reinforce layer 16 is formed using an injection-molding process, as a first step, a set of forming molds, i.e., an upper mold and a lower mold which are movable with respect to each other to open or close the space therebetween, is provided. The inner surface of the cavity formed in the lower mold has the same shape as the outer surface of the steering wheel 10. Next, the preliminarily shaped decorative layer 15 is put in the cavity of the lower mold, the upper mold is moved to close the cavity, resin is injected into the space between the decorative layer 15 and the upper mold to form the reinforce layer 16 by injection-molding, and the integrated surface element 14 is removed from the molds. The temperature of a cylinder for injection-molding is preferably set to 150 to 330° C., the temperature of the molds is preferably set to 50 to 160° C., and the injection pressure is preferably set to 30 to 150 MPa. In this process, by the injection-molding pressure, the decorative layer 15 is formed in a shape corresponding to the inner surface of the cavity formed in the lower mold.

When a forming material such as SMC or BMC is stacked onto the decorative layer 15 so as to be integrated, as a first step, a set of forming molds, i.e., an upper mold and a lower mold which are movable with respect to each other to open or close the space therebetween, is provided. The inner surface of the cavity formed in the lower mold has the same shape as the outer surface of the steering wheel 10. Next, the lower mold is heated to 100 to 150° C., the preliminarily shaped decorative layer 15 is put in the cavity of the lower mold, and the forming material such as SMC or BMC having been cut into strips is applied to the decorative layer 15. Next, the upper mold is moved to close the cavity and then a heating and pressurizing forming step is performed, wherein the preferred conditions are as follows: the temperature of the molds is 100 to 150° C.; the mold retaining pressure is 2 to 8 MPa; and the holding period in the mold is 3 to 5 minutes. After maintaining these conditions for a predetermined period, the integrated surface element 14, consisting of the decorative layer 15 and the reinforce layer 16, is removed from the molds.

After forming the surface element 14, undesirable portions such as flashes produced during the shaping process are removed from the surface element 14.

Next, as shown in FIG. 2, one end of a glass fiber cloth or the like to form the fiber reinforcing layer 17 is tentatively attached (i.e., spot-adhered) to the inner surface of the surface element 14 forming the front side of the steering wheel 10 with an instantaneous adhesive agent or the like. A glass fiber cloth or the like may be disposed along the entire inner surface of the surface element 14 to form the front side and along the entire inner surface of the surface element 14 to form the back side, instead of being tentatively attached as mentioned above.

Next, the surface element 14 to form the front side of the steering wheel 10 and the surface element 14 to form the back side of the steering wheel 10 are disposed in the cavity of a set of forming molds so as to abut each other, while the metal core 12 is disposed at the center thereof.

Next, the upper mold is moved to close the cavity, and then a foamable resin such as a foamable epoxy resin is supplied into the space between the surface elements 14 and 14 and the metal core 12 so as to form the core material layer 13, and so as to integrate the surface elements 14 and 14, the metal core 12, and the fiber reinforcing layer 17, and thus a formed body for the steering wheel is obtained. In the forming step for the core material layer 13, the preferred temperature is 20 to 150° C., and the preferred duration is 3 to 60 minutes.

Then, the formed body for the steering wheel is removed from the molds, the seams 18 and 18 between the surface elements 14 and 14 are surface-finished using sandpaper or the like, and if necessary, a coloring process, a painting process, a grinding process, or the like is applied to obtain the steering wheel 10.

In order to clarify the advantageous effects of the present invention, a more specific example of the steering wheel according to the present invention will be explained below with reference to FIG. 1.

### EXAMPLE 1

A backed decorative layer, in which a non-woven fabric was applied at an area density of 50 g/m² onto a woody ply having a thickness of 0.2 mm, was provided as the decorative layer 15. Then, the backed decorative layer was preliminarily shaped using a curved-surface shaping process including a hot press step. The operating conditions for the hot press step were set to 120° C. for 3 minutes.

Next, an unsaturated polyester resin containing 30 wt. % of glass fibers was provided as an SMC material.

Next, the lower mold of a set of molds for forming the surface element 14 was heated to 140° C., the preliminarily shaped decorative layer 15 was put in the cavity of the lower mold, and the SMC cut into strips was applied to the decorative layer 15 along the inner surface thereof.

Next, the upper mold was moved to close the cavity and then a heating and pressurizing forming step was performed, wherein the operating conditions were set as follows: the temperature of the molds was 140° C.; the mold retaining pressure was 3 MPa; and the holding period in the mold was approximately 3 minutes. After maintaining these conditions for a predetermined period, the integrated surface element 14 consisting of the decorative layer 15 and the reinforce layer 16 was removed from the molds.

Then, undesirable portions such as flashes produced during the shaping process were removed from the surface element 14. The thickness of the formed surface element 14 was approximately 0.5 to 3.0 mm near the seam 18, and was approximately 0.5 to 7.0 mm at the top thereof.

Next, the surface element 14 to form the front side of the steering wheel 10 and the surface element 14 to form the back side of the steering wheel 10 were disposed in the cavity of a set of molds for forming a steering wheel so as to abut each other, while the metal core 12 was disposed at the center thereof.

Then, one end of a glass fiber woven cloth, which consisted of a single layer in which the diameter of each of the fibers was 10 μm, the area density thereof was 100 g/m², the thickness thereof was 120 μm, and the width thereof was 15 mm, to form the fiber reinforcing layer 17 was tentatively attached to the inner surface of the surface element 14 forming the front side of the steering wheel 10 with an instantaneous adhesive agent or the like.

Next, the upper mold was moved to close the cavity, and then a foamable urethane resin containing 30 wt. % of glass fibers each having a length of 25 mm was supplied into the space between the surface elements 14 and 14 and the metal core 12 so as to form the core material layer 13, and so as to integrate the surface elements 14 and 14, the metal core 12, and the fiber reinforcing layer 17, and thus a formed body for the steering wheel was obtained. In the forming step for the core material layer 13 using the above-mentioned foamable urethane resin, the temperature was set to 50° C., and the duration was set to approximately 10 minutes.

Then, the formed body for the steering wheel was removed from the molds, the seams 18 and 18 between the surface elements 14 and 14 were surface-finished using sandpaper or the like, and as required, a coloring process, a painting process, a grinding process, or the like was applied to obtain the steering wheel 10.

### EXAMPLE 2

A 3-ply decorative layer was provided as the decorative layer 15, in which a woody ply 0.2 mm thick forming a surface layer was adhered to one surface of a thin aluminum plate 0.1 thick using a thermosetting adhesive, and another woody ply 0.2 mm thick forming an inner layer was adhered to the other surface of the thin woody plate using a thermosetting adhesive.

Then, the 3-ply decorative layer was preliminarily shaped using a curved-surface shaping process including a vacuum press step. The operating conditions for the vacuum press step were set to 120° C. for 3 minutes.

Next, an unsaturated polyester resin containing 30 wt. % of glass fibers was provided as a BMC material.

Next, the lower mold of a set of forming molds was heated to 140° C., the preliminarily shaped decorative layer 15 was put in the cavity of the lower mold, and the BMC material having been cut into bar-shape was applied to the decorative layer 15 along the inner surface thereof.

Next, the upper mold was moved to close the cavity and then a heating and pressurizing forming step was performed, wherein the operating conditions were set as follows: the temperature of the molds was 140° C.; the mold retaining pressure was 3 MPa; and the holding period in the mold was approximately 3 minutes. After maintaining these conditions for a predetermined period, the integrated surface element 14 consisting of the decorative layer 15 and the reinforce layer 16 was removed from the molds.

Then, undesirable portions such as flashes produced during the shaping process were removed from the surface element 14. The thickness of the formed surface element 14 was approximately 1.0 mm near the seam 18. The thickness of the formed surface element 14 was approximately 1.5 mm at the top thereof.

Next, the surface element 14 to form the front side of the steering wheel 10 and the surface element 14 to form the back side of the steering wheel 10 were disposed in the cavity of a set of forming molds so as to abut each other, while the metal core 12 was disposed at the center thereof.

Then, one end of a fiber woven cloth, whose thickness was 100 μm, whose width was 15 mm, and which consisted of two carbon woven fabric layers in each of which the diameter of each of the fibers was 7 μm, the area density thereof was 100 g/m², the thickness thereof was 200 μm, and the width thereof was 15 mm, to form the fiber reinforcing layer 17 was tentatively attached to the inner surface of the surface element 14 forming the front side of the steering wheel 10 with an instantaneous adhesive agent or the like.

Next, the upper mold was moved to close the cavity, and then a foamable epoxy resin containing 30 wt. % of glass fibers each having a length of 25 mm was supplied into the space between the surface elements 14 and 14 and the metal core 12 so as to form the core material layer 13, and so as to integrate the surface elements 14 and 14, the metal core 12, and the fiber reinforcing layer 17, and thus a formed body for the steering wheel was obtained. In the forming step for the core material layer 13 using the above-mentioned foamable epoxy resin, the temperature was set to 140° C., and the duration was set to approximately 20 minutes.

Then, the formed body for the steering wheel was removed from the molds, the seams 18 and 18 between the surface elements 14 and 14 were surface-finished using sandpaper or the like, and as required, a coloring process, a painting process, a grinding process, or the like was applied to obtain the steering wheel 10.

### EXAMPLE 3

A plywood, in which a thin plate of polyphenylene sulfide having a thickness of 0.10 mm was adhered to the back surface a woody ply having a thickness of 0.20 mm, was provided as the decorative layer 15.

Then, the plywood was preliminarily shaped using a curved-surface shaping process including a hot press step. The operating conditions for the hot press step were set to 120° C. for 3 minutes.

Next, the lower mold of a set of forming molds was heated to 140° C.; the preliminarily shaped decorative layer 15 was put in the cavity of the lower mold; the SMC material having been cut into strips was applied to the decorative layer 15 along the inner surface thereof; the upper mold was moved to close the cavity; the temperature of the cylinder of an injection molding machine was set in a range from 320° C., the injection pressure was set in a range from 700 kg/cm², and the temperature of the forming molds was set in a range from 120° C.; an injection molding step was performed to form the decorative reinforce layer 16 of polyphenylene sulfide inside the decorative layer 15; and then after maintaining these conditions for a predetermined period, the integrated surface element 14 consisting of the decorative layer 15 and the reinforce layer 16 was removed from the molds.

Then, undesirable portions such as flashes produced during the shaping process were removed from the surface element 14. The thickness of the formed surface element 14 was approximately 1.0 mm near the seam 18. The thickness of the formed surface element 14 was approximately 1.5 mm at the top thereof.

Next, the surface element 14 to form the front side of the steering wheel 10 and the surface element 14 to form the back side of the steering wheel 10 were disposed in the cavity of a set of forming molds so as to abut each other, while the metal core 12 was disposed at the center thereof.

Then, one end of a stainless steel fiber woven cloth, which consisted of single layer in which the diameter of each of the fibers was 200 μm, the area density thereof was 300 g/m², the thickness thereof was 400 μm, and the width thereof was 15 mm, to form the fiber reinforcing layer 17 was tentatively attached to the inner surface of the surface element 14 forming the front side of the steering wheel 10 with an instantaneous adhesive agent or the like.

Next, the upper mold was moved to close the cavity, and then a foamable urethane resin containing 30 wt. % of alumina fibers each having a length of 30 mm was supplied into the space between the surface elements 14 and 14 and the metal core 12 so as to form the core material layer 13, and so as to integrate the surface elements 14 and 14, the metal core 12, and the fiber reinforcing layer 17, and thus a formed body for the steering wheel was obtained. In the forming step for the core material layer 13 using the above-mentioned foamable urethane resin, the temperature was set to 50° C., and the duration was set to approximately 10 minutes.

Then, the formed body for the steering wheel was removed from the molds, the seams 18 and 18 between the surface elements 14 and 14 were surface-finished using sandpaper or the like, and as required, a coloring process, a painting process, a grinding process, or the like was applied to obtain the steering wheel 10.

### INDUSTRIAL APPLICABILITY

As explained above, the steering wheel according to the present invention comprises: two surface elements, each formed by stacking a decorative layer and a reinforce layer, joined together at seams; a core material layer disposed to the inside of the surface elements; a metal core disposed to the inside of the core material layer, the surface elements, the core material layer, and the metal core being integrated to form the steering wheel; and fiber reinforcing layers which are provided between the reinforce layer and the core material layer, and which bridge one surface element and the other surface element across the seams of the surface elements. Accordingly, the elastic modulus and the heat distortion temperature of the core material layer near the seams are increased; therefore, the stress concentration at the seams due to thermal expansion of the core material layer can be prevented. Thus, cracking along the seams in the coating film formed on the surface of the decorative layers due to thermal expansion of the core material layer, can be prevented.

If the fiber reinforcing layers are of glass fibers, carbon fibers, aramide fibers, or metal fibers, the elastic modulus and the heat distortion temperature of the core material layer are increased; consequently, the thermal expansion of the core material layer at high temperature can be restrained.

If fibers each having a length of 25 mm or more are scattered in the core material layer, the elastic modulus and the heat distortion temperature of the core material layer are increased; consequently, the thermal expansion of the core material layer at high temperature can be restrained.

Although the invention has been described in detail herein with reference to its preferred embodiments and certain described alternatives, it is to be understood that this description is by way of example only, and it is not to be construed in a limiting sense. It is further understood that numerous changes in the details of the embodiments of the invention, and additional embodiments of the invention, will be apparent to, and may be made by, persons of ordinary skill in the art having reference to this description. It is contemplated that all such changes and additional embodiments are within the spirit and true scope of the invention as claimed.

What is claimed is:

1. A steering wheel, comprising:
two surface elements, each formed by stacking a decorative layer and a reinforce layer, joined together at seams;
a core material layer disposed to the inside of said surface elements;
a metal core disposed to the inside of said core material layer, said surface elements, said core material layer, and said metal core being integrated to form said steering wheel; and
fiber reinforcing layers which are provided between said reinforce layer and said core material layer, and which bridge one surface element and the other surface element across said seams of said surface elements.

2. A steering wheel according to claim 1, wherein said fiber reinforcing layers are made of at least one of glass fibers, carbon fibers, aramide fibers, and metal fibers.

3. A steering wheel according to claim 1, wherein said core material layer includes fibers scattered therein, each having a length of at least 25 mm.

4. A steering wheel according to claim 2, wherein said core material layer includes fibers scattered therein, each having a length of at least 25 mm.
